(19) United States
(12) Patent Application Publication
(10) Pub. No.: US 2026/0093394 A1
(43) Pub. Date: Apr. 2, 2026

(54) Method for Operating a Touch-Sensitive Display Device

(71) Applicant: Bayerische Motoren Werke Aktiengesellschaft, Muenchen (DE)

(72) Inventors: Yannick Forster, Muenchen (DE); Katharina Wiedemann, Muenchen (DE)

(21) Appl. No.: 19/110,416

(22) PCT Filed: Sep. 27, 2023
(86) PCT No.: PCT/EP2023/076653

§ 371 Date: Mar. 10, 2025

(30) Foreign Application Priority Data
Sep. 28, 2022 (DE) 10 2022 124 911.5

(51) Int. Cl. G06F 3/04886; B60K 35/22; B60K 35/81; G06F 3/14; G06V 20/59

(52) U.S. Cl. CPC G06F 3/04886; B60K 35/22; B60K 35/81; G06F 3/1423; B60K 2360/1438; G06V 20/593

(57) ABSTRACT

A method operates a touch-sensitive display device designed for displaying at least two control areas. The method includes determining at least one relative position of at least a first user of a set of users comprising one or more users in relation to the display device. The method also includes assigning at least one of the at least two control areas to the first user. The method further includes arranging the at least two control areas on the display device on the basis of the assignment to the first user and the relative position of the first user in relation to the display device.

The present application is the U.S. national phase of PCT Application PCT/EP2023/076653 filed on Sep. 27, 2023, which claims priority of German patent application No. 10 2022 124 911.5 filed on Sep. 28, 2022, the entire contents of which are incorporated herein by reference.

### TECHNICAL FIELD

Exemplary embodiments relate to a method for operating a touch-sensitive display device designed for displaying at least two control areas. Further exemplary embodiments relate to a system comprising a touch-sensitive display device and a vehicle comprising such a system.

### BACKGROUND

Modern motor vehicles are increasingly having large screens installed that vehicle occupants can also use to make inputs. Such touch-sensitive displays or touchscreens, in contrast to mere screens with keys, are deemed advantageous because firstly they require no extra installation space for keys or buttons and secondly the arrangement of the control areas on the display can be adapted according to the display content.

By way of example, it is known practice from the field of mobile radio to adapt the size of elements on touchscreens that display an input option (e.g. referred to as control areas). As such, e.g. experienced users may set a small size and in exchange display many such elements on a display, while other users may decide to display fewer larger input elements (e.g. control areas) (e.g. displaying apps that can be launched by clicking on the touch-sensitive screen).

More and more vehicles are equipped with touch-sensitive screens today. These touch-sensitive screens can be used to control a multiplicity of functions in the vehicle by way of control elements, for example air-conditioning and seat adjustment. In premium vehicles, there is one such screen e.g. for passengers in the first row of seats (driver and front-seat passenger), i.e. a front screen or front seat display, and one such screen for the passengers in the back, i.e. a rear screen or rear seat display.

It is also known practice to use an interior sensor system, for example comprising an interior camera and multiple seat pressure sensors, to determine an occupancy of the vehicle.

The document DE 10 2017 206 942 A1 discloses a display device for a motor vehicle, comprising a plurality of display elements. To permit a reduction in energy consumption and wear on a plurality of display elements of a motor vehicle, there is provision for a switching device for collectively switching on and switching off the plurality of display elements on the basis of a single switching signal, and a sensor device for detecting a seat occupancy of a seat in the motor vehicle by an occupant. All of the plurality of display elements are assigned to the seat in the motor vehicle, and the switching signal relates to the seat occupancy of the seat by the occupant.

The document EP 1 895 389 A2 discloses a computer system for dynamically adapting the size of touch-sensitive areas or “buttons” (e.g. control areas of the touch-sensitive display device) on touchscreens in response to the user's level of motor skill. Data from sensors arranged around a touchscreen send small changes in the user's hand position and forward these data to a filter, which separates the motion component due to tremor in the hand from the deliberate motion component. The information about the extent of the hand tremor can be used either to dynamically increase the size of a control when the user's hand moves or to retrieve and display a fixed screen layout comprising controls of appropriate size.

A disadvantage of known display systems may be that, nevertheless, not all users are able to operate the relevant control areas on touch-sensitive displays in a suitable manner. By way of example, it may be the case in vehicles that a passenger has to stretch a long way to reach a specific control area, which may be perceived as uncomfortable, for example.

There is a need, therefore, to provide improved designs for controlling a display on touch-sensitive screens and, in particular, to improve the arrangement of control areas on such a touch-sensitive screen.

### SUMMARY

The above-described needs, as well as others, can be satisfied by one or more embodiments disclosed herein.

Accordingly, a method for operating a touch-sensitive display device designed for displaying at least two control areas is proposed. Such control areas are, for example, control fields or areas on the touch-sensitive display device that trigger an action (e.g. activating a function) as a result of a touch from a user.

The method comprises the steps of: determining a relative position of a user or multiple users in relation to the display device; assigning at least one of the at least two control areas to one of the users; and arranging the at least two control areas on the display device on the basis of the assignment to the user and the user's relative position in relation to the display device.

The relative position of the user with respect to the touch-sensitive display device can comprise a distance and/or angle of the user with respect to the display device. The control areas can be used for example to activate or control various functions of the display device. Depending on which of these functions the user needs or is permitted to use, the user can accordingly be assigned the corresponding control areas for said functions. A user can therefore be assigned e.g. a set of control areas relevant to this user (which e.g. are meant to be able to be reached from the position of this user).

The arranging can comprise e.g. positioning the control areas on the touch-sensitive display device. The position of a specific control area on the touch-sensitive display device can be provided on the basis of the assignment of the specific control area to a user in combination with the position of this user in relation to the touch-sensitive display device. The arranging can alternatively or additionally comprise not displaying specific control areas, e.g. if they are assigned to none of the detected users and are therefore not needed. The arranging can furthermore alternatively or additionally comprise adapting a size of the control area for the user or for a surface area on the touch-sensitive display device that is available for control areas (e.g. larger display of the control areas when only a small number of control areas are displayed).

The method permits the control areas for the respective user to be positioned at a particularly suitable location on the display device and/or in a particularly suitable size on the basis of the assignment of the control areas to the user in combination with knowledge of the user's position with respect to the touch-sensitive display device. By way of example, this allows control areas that a user needs more often (for example higher-priority control areas) to be arranged and displayed closer to the user and/or displayed in a larger size than other control areas. By way of example, a display of control areas that the user does not need can be suppressed, at least in proximity to the user. This allows better use to be made of the screen space so that for example relevant control areas can be displayed in a larger size.

According to one example, there is provision for the arranging of the at least two control areas to comprise arranging a control area assigned to a first user at a position on the display device that is closer to the first user than to a second user. Accordingly, the arranging of the at least two control areas can for example furthermore conversely comprise arranging a control area assigned to the second user at a position on the display device that is closer to the second user than to the first user. This can allow for example different users to easily reach precisely the control areas that they actually need.

According to one example, there is provision for one of the at least two control areas to be shown in duplicate duplicate control areas being arranged closer to a first user and the second of the duplicate control areas being arranged closer to a second user. In contrast to other designs, in which for example one of the users or even both users cannot reach the control areas needed by both users in an optimum manner, the disclosed method can allow both users to reach the control areas from their respective position more comfortably.

According to one example, there is provision for the assigning of the control elements to comprise assigning one of multiple users none of the control elements and then arranging the control areas on the display device in such a way that they cannot be reached from the position of this user. By way of example, some display devices can provide functions that are not suitable for all users who are present or are not meant to be operated by all users who are present. Consequently, it is possible to prevent control areas corresponding to such functions from being assigned to the relevant users (i.e. such an assignment is not made). Advantageously, operation of these functions by the relevant users can therefore be prevented, because they cannot reach the required control areas. This aspect can be advantageous in particular in the case of display devices comprising multiple display elements (for example a respective display element assigned to a user or physically distributed display elements), as reaching the control areas that are arranged or displayed on another display element may be possible for the relevant users only with great difficulty or not at all.

According to one example, there is provision for the method to further comprise determining which of the at least two control elements are relevant to the users who are present. By way of example, this allows the assignment of the control areas to the user or users to be improved. The relevance can be determined for example by means of camera-based user recognition and/or use of a stored user profile (e.g. associated with a seat of the user). The arranging of the at least two control elements can involve only control elements relevant to the users who are present being arranged on the display device. Advantageously, displaying control areas that are relevant to no users who are present can therefore be dispensed with, for example. This allows better use of the available space on the screen, for example the displayed control areas can be displayed in a larger size, with the result that they can be used more easily, or more space can be used for displaying information.

According to one example, there is provision for the position to be determined on the basis of a camera or of seat occupancy information relating to a seat provided for the user. The method described above can be used for example in vehicles that already have appropriate sensors such as a camera or seat occupancy sensors. This allows efficient use of elements of the vehicle that are already present in order to be able to carry out the method.

Another aspect relates to a system comprising a touch-sensitive display device designed for displaying at least two control areas, wherein the system comprises a control unit designed to carry out a method as described above or below. The system can be used for example in a vehicle or alternatively in end user devices operated by multiple users (e.g. public terminals comprising a touchscreen or mobile devices for use by multiple users).

According to one example, there is provision for the system to be designed for use in a vehicle, the control unit being designed so as, when arranging the at least two control areas, to show the control areas that are shown on the display device in a larger size when the number of users is lower than when the number of users is higher. By way of example, there may be provision for the size of the control areas to be controlled in a manner inversely proportional to the number of control areas displayed. By way of example, a higher number of users may require a high number of control areas to be displayed if they are needed by the users, whereas fewer users may need a lower number of control areas. As a specific surface area on the touch-sensitive display device may be available for displaying the control areas, it may be possible to show the control areas in a larger size when there is a lower number of them. This can permit more comfortable operation for the users, for example.

According to one example, there is provision for the display device to comprise at least two physically separate display elements. The two or more separate display elements may be for example individual displays that may be assigned to different users (for example arranged at respective seats of the users). The different display elements can be driven by means of a common controller. The system can permit the respective displays to be used to display only such control areas as are relevant to the respective user of the display. This allows control areas that a user does not need at all to be prevented from being displayed, for example. Furthermore, by suppressing the display of control areas for specific users, it is possible to prevent these users from being able to operate a function that is controlled by means of the control areas.

According to one example, there is provision for the system to be designed for use in a vehicle, the display device comprising a front seat display and a rear seat display, the control unit being designed to arrange control areas exclusively on the front seat display if the rear seat of the vehicle holds (e.g. exclusively) users who are unauthorized to operate the display device. By way of example, it may be that a vehicle rear seat has children sitting in it who are not meant to be able to operate specific functions. If the control areas needed for operating these functions are not displayed on the rear seat display of the vehicle, it may be very difficult or quite impossible for the passengers in the rear seat to operate these functions.

According to one example, there is provision for the system to be designed for use in a vehicle, the display device comprising a front seat display and a rear seat display, the control unit being designed to deactivate the rear seat display if the rear seat holds no users. This allows unnecessary energy consumption to be avoided in the vehicle when the rear seat display is not needed at all.

Aspects relate to a vehicle comprising a system as described above or below. A control unit of the system (e.g. onboard computer of the vehicle) is designed to arrange the at least two control areas on the touch-sensitive display device flexibly on the basis of a vehicle occupancy of the vehicle. The vehicle occupancy can describe the position and type of passengers who are in the vehicle (e.g. driver, front seat passenger, child, etc.). On the basis of the disclosed design, control areas can be arranged on the display device such that they can be reached particularly comfortably by a user who wishes to use them. This allows a flexible reaction to vehicle occupancy.

By way of example, a passenger in the vehicle may first sit in the front seat passenger's seat and, during this time, relevant control areas can be displayed for this passenger on the right-hand side of a front display arranged centrally in the vehicle, whereas a rear seat display may be deactivated. Deactivating the display that is not needed can lead to energy savings. If this passenger changes to the rear seat, a display of the control areas previously displayed on the right-hand side of the front seat display can be suppressed, the rear seat display can be activated and the control areas that are relevant to the passenger can be displayed on the rear seat display.

Examples relate to a computer program that comprises a program code in order to carry out a disclosed method when the computer program is executed on a processor, a computer or programmable hardware. Such a computer program may advantageously be provided on a storage medium. For example, it may be provided and executed on a control unit of a device (e.g. vehicle), with the result that control of the display on vehicle displays and of the control areas displayed thereon can be permitted in a manner adapted for the positions of the passengers in the vehicle.

The above-described features and advantages, as well as others, will become more readily apparent to those of ordinary skill in the art by reference the following detailed description and accompanying drawings.

### BRIEF DESCRIPTION OF THE DRAWINGS

FIG. 1 shows a flowchart for a method for operating a touch-sensitive display device;

FIG. 2 shows a schematic example of a system with a touch-sensitive display device and two users; and

FIG. 3 shows a schematic example of a system with a touch-sensitive display device comprising two separate display elements.

### DETAILED DESCRIPTION

Various exemplary embodiments will now be described in more detail with reference to the accompanying drawings, which show some exemplary embodiments. In the figures, the thickness dimensions of lines, layers and/or regions may be shown in exaggerated fashion for the sake of clarity. In the description of the attached figures that follows, which figures merely show some illustrative exemplary embodiments, identical reference signs can denote identical or comparable components.

An element that is denoted as “connected” or “coupled” to another element may be directly connected or coupled to the other element, or intervening elements may be present. Unless defined otherwise, all terms used herein (including technical and scientific terms) have the same meaning ascribed to them by a person of average skill in the art in the field to which the exemplary embodiments belong.

According to other designs, the display of the control elements on the touch-sensitive screens of a vehicle is static. As a result, e.g. occupants who are not meant to operate the control elements or cannot operate them properly can control functions in the vehicle easily and without authorization.

Additionally, it may be that the space on the touch-sensitive screens is not used in optimum fashion. A disadvantage of known designs may be that a display of the control elements is optimized only to the needs of a single user.

It is therefore proposed that the display for example on the front and rear screens of a vehicle be flexibly adapted for the occupants of the vehicle.

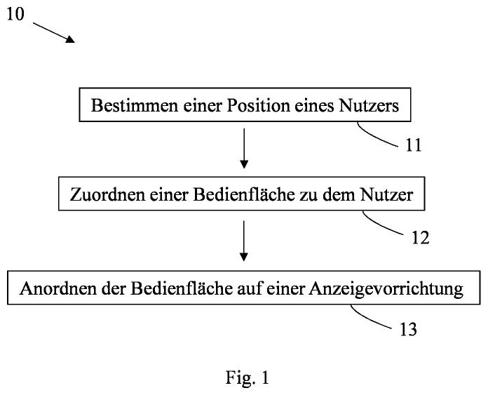

FIG. 1 shows a flowchart for a method 10 for operating a touch-sensitive display device. The touch-sensitive display device is designed for displaying at least two control areas. The method 10 comprises the steps of: determining 11 a relative position of a user or multiple users in relation to the display device; assigning 12 at least one of the at least two control areas to one of the users; and arranging 13 the at least two control areas on the display device on the basis of the assignment to the user and the user's relative position in relation to the display device.

The method 10 can advantageously be used in a vehicle, e.g. in order to arrange or show content, and the control areas thereof, that is displayed on the touch-sensitive display device in a manner adapted for occupants who are in the vehicle. By way of example, the control areas can be displayed on a front and rear seat display of the display device of the vehicle.

By way of example, a first step can involve the interior sensor system (e.g. camera, seat pressure distribution system, etc.) determining whether and if applicable which seats in the vehicle have occupants. From this, it is possible to determine the distance and direction from the display (relative position in relation to the display) that the respective occupant is seated or is at.

By way of example, a second step can involve determining whether or not each of the occupants present is meant to be able to operate vehicle functions (e.g. assigning the functions to the individual users), and/or whether they are e.g. human beings or animals (for example dogs). In other words, the functions linked to the control areas can be assigned to the users.

If, for example, it is detected that only the driver is present, the display on the front screen can be adapted such that only functions needed by the driver are able to be controlled. As such, for example the control elements (e.g. control areas on the touch-sensitive display device) associated with the air-conditioning for the front seat passenger's side and/or the control elements associated with the air-conditioning for the passengers in the rear can be omitted (for example seat operation or rear seat entertainment can also be omitted if the persons in question are not present).

If it is detected that a passenger (for example a child and/or an animal) should not operate a nearby screen (for the front seat passenger the front screen, for the passengers in the rear the rear screen) as e.g. they cannot operate the nearby screen properly, the relevant control elements for their seat position (for example air-conditioning, seat operation, etc.) can be positioned on the front screen so as to be able to be reached only by the driver (e.g. so as to be able to be reached particularly well by the driver).

If it is detected that a passenger can operate the nearby screen themselves, the control elements can be positioned on a screen near to the seat position so as to be better able to be reached by this seat position.

The display on the front and rear screens can be adapted such that the space on the respective screen can be used in optimum fashion. If the driver is alone in the vehicle, for example, there is thus much more space available on the screen and the control elements associated with other functions can be displayed in a much larger size (for example because control areas that the driver e.g. does not need or that only a front seat passenger needs are not displayed and there is therefore more space available on the display).

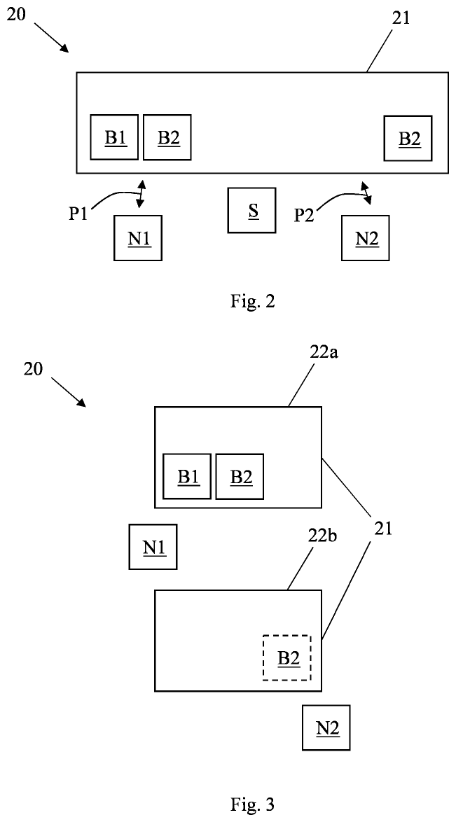

FIG. 2 shows a schematic example of a system 20 with a touch-sensitive display device 21 and two users N1, N2. The two users N1, N2 are e.g. the driver and front seat passenger of a vehicle. Accordingly, the driver N1 in a driver's seat may be in a first relative position P1 in relation to the touch-sensitive display device 21 and the front seat passenger N2 in the front seat passenger's seat may be in a second relative position P2 in relation to the touch-sensitive display device 21. When the vehicle display 21 is arranged centrally, for example, the two positions P1, P2 may be the same distance away from said vehicle display, the first position Pl being to the left of the display and the second position P2 being to the right of the display.

The two positions P1, P2 of the two users N1, N2 can be determined by means of a sensor S of the system 20 (e.g. interior camera of the vehicle or seat occupancy sensor). The touch-sensitive display device 21 can be used to provide the users N1, N2 with specific functions that can be controlled by means of control areas B1, B2. It is possible to determine which of the users N1, N2 is meant to operate which functions, and therefore to assign which of the control areas B1, B2 is relevant to the respective user N1, N2. By way of example, an onboard computer or control unit (not shown) of the vehicle can be used to output a content to the touch-sensitive display device 21. This content can comprise not only mere display areas (e.g. without a control function) but also the touch-sensitive control areas. By way of example, touching the first control area B1 can result in a first function being activated or adjusted and touching the second control area B2 can result in a second function being activated or adjusted.

By way of example, the driver N1 in the example shown can be assigned the first and second control areas, as the driver is meant to be able to operate the corresponding functions, and the front seat passenger N2 can be assigned only the second control area B2. According to the first position P1 of the driver N1, the two control areas B1, B2 are therefore arranged at a position on the left-hand side of the touch-sensitive display device 21 that is near to the driver N1, so that the driver can comfortably reach them. Since the front seat passenger N2 is also meant to be able to use the control area B2, said control area can be displayed in duplicate and additionally also displayed at a right-hand position on the touch-sensitive display device 21 that is near to the front seat passenger N2, so that the front seat passenger can also comfortably reach the second control area B2. By way of example, the second, duplicate control area B2 can be displayed in a larger size for the front seat passenger N2 than for the driver N1, since the first control area B1 does not need to be displayed for the front seat passenger N2 and there may therefore be more space available on the right-hand side of the touch-sensitive display device 21.

Further details and aspects are mentioned in connection with the exemplary embodiments described above or below. The exemplary embodiment shown in FIG. 2 can have one or more optional additional features that correspond to one or more aspects mentioned in connection with the design or with one or more exemplary embodiments described above (e.g. FIG. 1) or below (e.g. FIG. 3).

FIG. 3 shows a schematic example of a system 20 with a touch-sensitive display device 21 comprising two separate display elements 22a, 22b. The separate display elements 22a, 22b may be e.g. a front seat display 22a and a rear seat display 22b of a vehicle.

By way of example, an onboard computer or control unit (not shown) of the vehicle can be used to output a content to the two display elements 22a, 22b. The first and second control areas B1, B2 of the content can be shown in a manner distributed between the two display elements 22a, 22b.

A sensor (not shown here) can be used to detect that, according to the example shown, the first user N1 is sitting in a front seat and can therefore operate the front seat display 22a. The second user N2, according to the example, is sitting in the rear seat and can therefore operate the rear seat display 22b.

It may be possible that the second user N2 is unauthorized to be able to make any input on the touch-sensitive display device 21. It may therefore be possible for the touch-sensitive control areas B1, B2 to be displayed only on the front seat display 22a, where they can be operated by the first user N1. The second user N2 cannot reach the control areas B1, B2 in this case and therefore cannot operate them.

It may optionally also be possible that the second user (e.g. a child) is permitted to use limited functions of the entertainment system. In this case, for example the second control area B2, e.g. designed for controlling a video display, can be displayed on the rear seat display 22b, while the first control area B1, e.g. designed for adjusting the air-conditioning system, is displayed only on the front seat display 22a and can therefore be operated only by the first user N1.

Further details and aspects are mentioned in connection with the exemplary embodiments described above or below. The exemplary embodiment shown in FIG. 3 can have one or more optional additional features that correspond to one or more aspects mentioned in connection with the design or with one or more exemplary embodiments described above (e.g. FIG. 1-2) or below.

Examples relate to a method for an automatic display on at least one screen in the vehicle in a manner adapted for the occupants (e.g. users N1, N2). As a result, e.g. the display on the front and rear screens (e.g. front and rear seat displays 22a, 22b) can be adapted such that the space on the respective screen can be used in optimum fashion (e.g. hiding control areas for users who do not need them; e.g. size of the control areas on the different screens is adapted for users). Reachability of control areas on the screens can also be improved for the passengers. If the driver N1 is alone in the vehicle, for example, this allows much more space to be made available on the screen 21, 22a, and the control elements B1, B2 associated with other functions can be e.g. positioned better and/or displayed in a much larger size. A design can therefore be provided for improved operation of a screen display on a touch-sensitive screen 21.

1.-13. (canceled)

14. A method for operating a touch-sensitive display device designed for displaying at least two control areas, the method comprising:
determining at least one relative position of at least a first user of a set of users comprising one or more users in relation to the display device;
assigning at least one of the at least two control areas to the first user; and
arranging the at least two control areas on the display device based at least in part on the assignment to the first user and the relative position of the first user in relation to the display device.

15. The method as claimed in claim 14, wherein the arranging of the at least two control areas comprises arranging a control area assigned to the first user at a position on the display device that is closer to the first user than to a second user of the set of users.

16. The method as claimed in claim 14, further comprising determining which of the at least two control areas is or are relevant to the set of users, and wherein arranging the at least two control areas comprises arranging only control areas relevant to the set of users.

17. The method as claimed in claim 16, wherein:
one of the at least two control areas is shown in duplicate if it is assigned to two users of the set of users, and
a first of the duplicate control areas being arranged closer to one of the two users and a second of the duplicate control areas being arranged closer to another of the two users.

18. The method as claimed in claim 14, wherein:
one of the at least two control areas is shown in duplicate if it is assigned to two users of the set of users, and
a first of the duplicate control areas being arranged closer to one of the two users and a second of the duplicate control areas being arranged closer to another of the two users.

19. The method as claimed in claim 14, wherein:
the set of users comprises a plurality of users; and
assigning the at least one of the at least two control areas comprises assigning one of the set of users none of the control areas and then arranging the at least two control areas on the display device in such a way that they cannot be reached from a position of the one of the set of users.

20. The method as claimed in claim 14, further comprising
determining which of the at least two control areas is or are relevant to the set of users, wherein arranging the at least two control areas comprises arranging only control areas relevant to the set of users.

21. The method as claimed in claim 14, wherein determining at least one relative position comprises determining the at least one relative position using a camera.

22. The method as claimed in claim 14, wherein determining at least one relative position comprises determining the at least one relative position using seat occupancy information relating to a seat provided for the first user.

23. A non-transitory storage medium comprising program code, which carries out the method as claimed in claim 14 when the program code is executed on a processor, a computer or programmable hardware.

24. A system comprising a touch-sensitive display device designed for displaying at least two control areas, wherein the system comprises a control unit designed to carry out a method as claimed in claim 14.

25. The system as claimed in claim 24, wherein:
the system is configured for use in a vehicle, and
the control unit is configured to perform arranging the at least two control areas by showing each of the at least two control areas on the display device in a larger size when a quantity of users is lower than when the quantity of users is higher.

26. The system as claimed in claim 25, wherein the display device comprises at least two physically separate display elements.

27. The system as claimed in claim 25, wherein:
the display device comprises a front seat display and a rear seat display, and
the control unit is configured to perform arranging the at least two control areas exclusively on the front seat display responsive to a determination that a rear seat of the vehicle holds one or more users who are unauthorized to operate the display device.

28. The system as claimed in claim 24, wherein:
the system is configured for use in a vehicle,
the display device comprises a front seat display and a rear seat display,
the control unit is configured to perform arranging the at least two control areas exclusively on the front seat display responsive to a determination that a rear seat of the vehicle holds users who are unauthorized to operate the display device.

29. The system as claimed in claim 24, wherein the display device comprises at least two physically separate display elements.

30. The system as claimed in claim 24, wherein:
the system is configured for use in a vehicle,
the display device comprises a front seat display and a rear seat display, and
the control unit is configured to deactivate the rear seat display if a rear seat of the vehicle holds no users.

31. A vehicle comprising a system as claimed in one of claim 24, wherein the control unit is configured to perform arranging the at least two control areas on the touch-sensitive display device flexibly on the basis of a vehicle occupancy of the vehicle.
